(19) United States
(12) Patent Application Publication
(10) Pub. No.: US 2022/0365725 A1
(43) Pub. Date: Nov. 17, 2022

(54) DATA STRUCTURE ENGINE

(71) Applicant: Advanced Micro Devices, Inc., Santa Clara, CA (US)

(72) Inventors: Michael Ignatowski, Austin, TX (US); Valentina Salapura, Santa Clara, CA (US); Ganesh Dasika, Austin, TX (US); Gabriel H Loh, Bellevue, WA (US)

(21) Appl. No.: 17/741,403

(22) Filed: May 10, 2022

Related U.S. Application Data
(60) Provisional application No. 63/187,368, filed on May 11, 2021.

(51) Int. Cl. G06F 3/06

(52) U.S. Cl. CPC G06F 3/0659; G06F 3/0604; G06F 3/0679

(57) ABSTRACT

A method includes receiving from a compute element a command for performing a requested operation on data stored in a memory device, and in response to receiving the command, performing the requested operation by generating a plurality of memory access requests based on the command and issuing the plurality of memory access requests to the memory device.

### CROSS-REFERENCE TO RELATED APPLICATIONS

This application claims priority to U.S. Provisional Application No. 63/187,368, filed on May 11, 2021, which is incorporated by reference herein in its entirety.

### BACKGROUND

Data structures are often used in modern computing system to manage and store data in a format that allows operations to be performed on the data more efficiently. In general, a data structure is a collection that can include data values, the relationships between the data values, functions or operations that can be applied to the data, etc. Some examples of data structures include arrays, linked lists, hash tables, graphs, and others. Specialized data structures can also be defined to store a particular type of data for a particular application or task. Data structures are especially useful for managing very large amounts of data, such as large databases, internet indexes, social network graphs, etc.

Data structures can be used to organize data that is stored in either main memory or secondary memory. However, memory operations on complex data structures can often result in sparse data accesses, further resulting in poor cache locality and the transfer of many bytes of data that are not actually used. In addition, these data structures are often accessed with a large number of memory accesses, while traditional sequential processing elements can be limited in the number of outstanding memory operations they generate.

### BRIEF DESCRIPTION OF THE DRAWINGS

The present disclosure is illustrated by way of example, and not by way of limitation, in the figures of the accompanying drawings.

FIG. 1 illustrates a computing system, according to an embodiment.

FIG. 2 illustrates processing and memory nodes in a computing system, according to an embodiment.

FIG. 3 is a block diagram illustrating components of a data structure engine, according to an embodiment.

FIGS. 4A and 4B illustrate locations of data structure engines in a computing system, according to an embodiment.

FIGS. 5A and 5B illustrate locations of data structure engines in a computing system, according to an embodiment.

FIG. 6 is a flow diagram illustrating a process for operating a data structure engine in a computing system, according to an embodiment.

### DETAILED DESCRIPTION

The following description sets forth numerous specific details such as examples of specific systems, components, methods, and so forth, in order to provide a good understanding of the embodiments. It will be apparent to one skilled in the art, however, that at least some embodiments may be practiced without these specific details. In other instances, well-known components or methods are not described in detail or are presented in a simple block diagram format in order to avoid unnecessarily obscuring the embodiments. Thus, the specific details set forth are merely exemplary. Particular implementations may vary from these exemplary details and still be contemplated to be within the scope of the embodiments.

Conventional memory operations on complex data structures often result in sparse data accesses resulting in poor cache locality and the transfer of many bytes of data that are not actually used. These data structures often require a large number of memory accesses, but traditional sequential processing elements can be limited in the number of outstanding memory operations they generate. As an example, accessing rows and columns of an n-dimensional array in an out-of-order fashion can result in memory references scattered all over memory. Another example is a strided access, where every nth element of an array is requested. This could cause a large number of cache lines to be requested where a small amount of data in each cache line is used, and most of the data is not used.

One embodiment of a computing system includes one or more data structure engines to accelerate memory operations on complex data structures. A data structure engine is an accelerating functional unit that operates on complex data structures which are stored in a memory system with a traditional (typically linear) address space. The data structure engine translates operations on one or more types of complex data structure into a collection of basic memory operations on physical addresses, and may also execute arithmetical or logical operations.

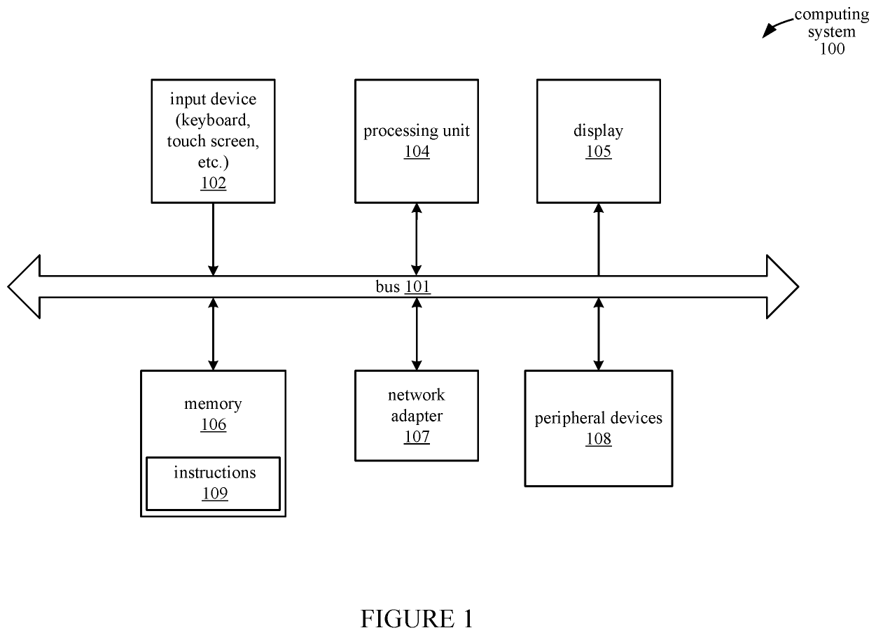

FIG. 1 illustrates an embodiment of a computing system 100 which implements data structure engines as described above. In general, the computing system 100 is embodied as any of a number of different types of devices, including but not limited to a laptop or desktop computer, mobile device, server, network switch or router, etc. The computing system 100 includes a number of hardware resources, including components 102-108, which communicate with each other through a bus 101. In computing system 100, each of the components 102-108 is capable of communicating with any of the other components 102-108 either directly through the bus 101, or via one or more of the other components 102-108. The components 101-108 in computing system 100 are contained within a single physical enclosure, such as a laptop or desktop chassis, or a mobile phone casing. In alternative embodiments, some of the components of computing system 100 are embodied as external peripheral devices such that the entire computing system 100 does not reside within a single physical enclosure.

The computing system 100 also includes user interface devices for receiving information from or providing information to a user. Specifically, the computing system 100 includes an input device 102, such as a keyboard, mouse, touch-screen, or other device for receiving information from the user. The computing system 100 displays information to the user via a display 105, such as a monitor, light-emitting diode (LED) display, liquid crystal display, or other output device.

Computing system 100 additionally includes a network adapter 107 for transmitting and receiving data over a wired or wireless network. Computing system 100 also includes one or more peripheral devices 108. The peripheral devices 108 may include mass storage devices, location detection devices, sensors, input devices, or other types of devices used by the computing system 100.

Computing system 100 includes a processing unit 104. The processing unit 104 receives and executes instructions 109 that are stored in a memory system 106. In one embodiment, the processing unit 104 includes multiple processing cores that reside on a common integrated circuit substrate. Memory system 106 includes memory devices used by the computing system 100, such as random-access memory (RAM) modules, read-only memory (ROM) modules, hard disks, and other non-transitory computer-readable media.

Some embodiments of computing system 100 may include fewer or more components than the embodiment as illustrated in FIG. 1. For example, certain embodiments are implemented without any display 105 or input devices 102. Other embodiments have more than one of a particular component; for example, an embodiment of computing system 100 could have multiple processing units 104, buses 101, network adapters 107, memory systems 106, etc.

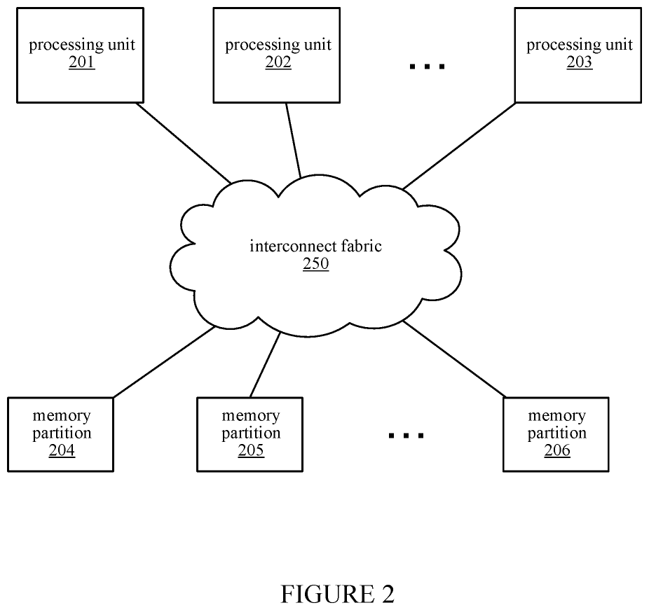

In one embodiment, the computing system 100 is a non-uniform memory access (NUMA) system in which the processing units 104 are implemented as multiple processing elements and memory partitions connected by interconnect fabric 250, as illustrated in FIG. 2. The interconnect fabric 250 connects multiple NUMA computing nodes together, which include processing elements 201-203 and memory partitions 204-206. In one embodiment, these computing nodes 201-206 reside within the same device package and on the same integrated circuit die. For example, all of the nodes 201-206 can be implemented on a monolithic central processing unit (CPU) die having multiple processing cores. In an alternative embodiment, some of the nodes 201-206 reside on different integrated circuit dies. For example, the nodes 201-206 can reside on multiple chiplets attached to a common interposer, where each chiplet has multiple (e.g., 4) processing cores.

The interconnect fabric 250 includes a switch network and multiple interconnect links that provide, for each of the nodes 201-206, a transmission path to communicate with any other one of the nodes 201-206. In one embodiment, the interconnect fabric 250 provides multiple different transmission paths between any pair of origin and destination nodes, and a different transmission path for any given origin node to communicate with each possible destination node.

In the computing system 100, one or more data structure engines reside in the communication path between the processing elements 201-203 and the memory partitions 204-206 to provide an interface for the processing elements 201-203 to access data in the memory partitions 204-206. Instead of a traditional programming model that generates a sequential set of memory operations on small data words (typically 1-8 bytes), a data structure engine has multiple address calculation units that operate in parallel to generate a large number of outstanding memory accesses with a variety of data block sizes. Data structure engines as described herein accelerate memory operations on complex data structures, enabling the generation of a large number of outstanding memory operations in parallel on varying size blocks of data. By collocating the functions near memory, it reduces the interconnect bandwidth requirements.

In one embodiment, the data structure engine is implemented as a near-memory functional unit with high bandwidth direct access to memory. When performing functions on complex data structures, it sends or receives data on behalf of another device (compute core, network interface, remote node, etc.), or load/stores to an internal scratchpad memory. The data structure engine can perform various operations on data in the internal scratchpad memory.

The data structure engine is designed to work on the same system as the other compute elements, operating on the same memory address space controlled by the same operating system. It can generate snoop requests to maintain cache coherency for a data structure with caches in other processing elements. It can perform address translation on virtual addresses. It can control and exploit other processing-in-memory functions if these functions are present in the memory. In one embodiment, the data structure engine incorporates many of the functions of a memory controller, including: translating between logical addresses as viewed by a processing unit and a physical address within a memory device, and performing refresh, wear leveling, remapping, scrubbing or other reliability, availability, and serviceability (RAS) functions, prevent row-hammer attacks, or any other memory technology specific operations.

Data structure operations performed by the data structure engine may utilize knowledge of different data structure types (e.g., dimensions of matrices or arrays, etc.) and may include multiple memory operations that can be invoked by a single command received from a processor core or other device. Some operations may manipulate data in the memory without returning data to the requesting device (e.g., matrix transformations, sorting, etc.), and some may rely on scratchpad memory in the data structure engine to perform reordering or intermediate computations. Example data structure operations include:
Data copy/move
Load/store N-dimensional matrix structures, or subsets of such matrix structures.
Load/store N-dimensional sparse matrix structure.
Matrix transpose
Strided data accessing
Gather/scatter and other sparse data operations
Encrypt/Decrypt data structures
Compress/expand data structures
Access indexed data structures
Access/manipulate linked lists
Access through lookup-tables
Key-value operations
Basic graph operations
Basic data-base operations
Restructure data locations to improve memory performance
Prefetch data structures
Garbage collection
Scan operations such as: search for a value, find min/max, sum components, scan for known viruses, deduplication, etc.
Atomic operations on a single memory location, or a locked/transactional operation on a group of locations.
Instrumentation and tracing
filtering and selection of data
data structure format conversion (e.g., dense→sparse)
data format conversion (e.g., float→integer, double precision floating point (FP64)→single precision floating point (FP32))

In one embodiment, computing system 100 includes multiple data structure engines, each collocated with a portion of memory for fulfilling requests directed to its respective portion of memory. Alternatively, the data structure engines are physically collocated with other processing, network interface units, or embedded in a system interconnect fabric or switch. Embodiments of the data structure engine are located closer to the memory than to the processor core or other device issuing requests to the data structure engine, and have a higher bandwidth communication channel with the memory than the processor core or other device. Each data structure engine operates on an address space that is shared with the processor core or other device. Functions in the data structure engine can be performed by hardwired or reconfigurable logic, by programmable firmware, or by executable code supplied by an application.

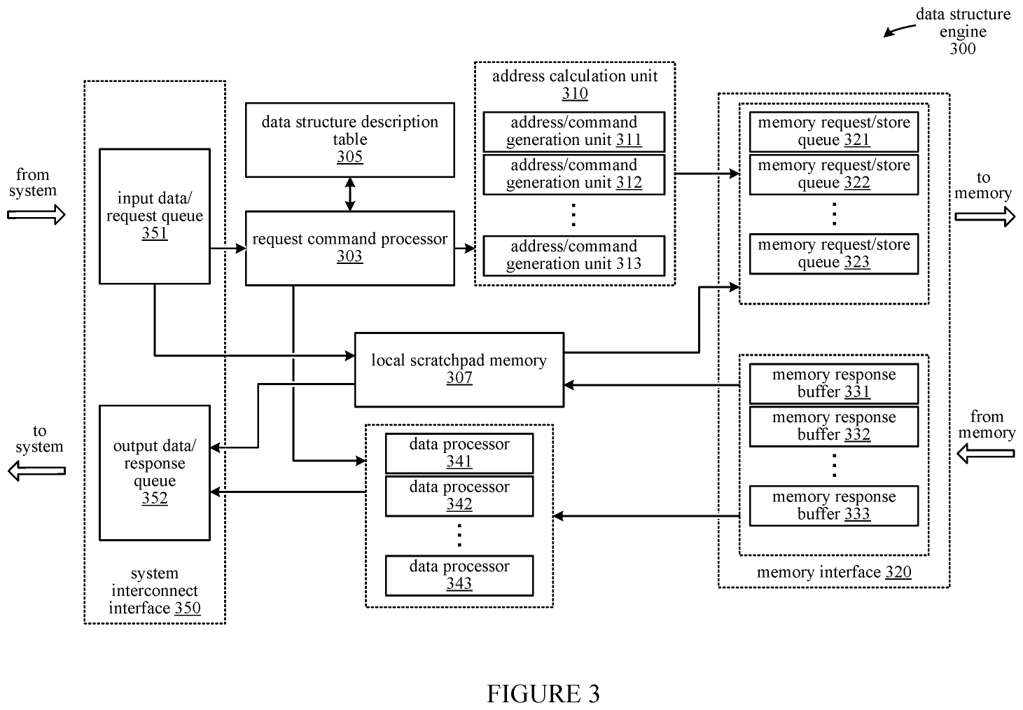

FIG. 3 illustrates components of a data structure engine 300, according to an embodiment. The data structure engine 300 includes a system interconnect interface 350, including an input queue 351 for receiving input data and commands. The input queue 351 receives and buffers commands issued by processor cores or other compute devices that are transmitted to the data structure engine 300 via the interconnect 250, and sends the commands to the request command processor 303. The system connect interface 350 also includes an output queue 352 for data and responses to be transmitted to other devices via the interconnect 250.

The data structure engine 300 includes the request command processor 303, which receives from a compute element (e.g., one of the processing units 201-203) a command for performing a requested operation on data stored in a memory device (e.g., one of the memory partitions 204-206). Upon receiving one or more request commands, the command processor 303 determines what memory requests need to be generated for executing each command. When a command requests an operation to be performed on data stored in a data structure, the request command processor 303 determines which memory requests to generate based on a definition of the data structure in the data structure description table 305.

The data structure description table 305 stores information about different data structures that may be stored in the memory associated with the data structure engine 300. For example, the table 305 may store the dimensions N and M of a N×M matrix data structure. In one embodiment, information stored in the data structure description table 305 is explicitly loaded by a command from an external device, or in alternative embodiments, embedded in a command to operate on that data structure.

The data structure engine 300 includes an address calculation unit 310 with multiple address/command generation units 311-313 that generate memory access requests in parallel according to instructions provided by the request command processor 303 for performing the requested command. For example, the request command processor may provide a base address, stride length, and a number of read requests for one or more of the address/command generation units 311-313 to generate. The address/command generation units 311-313 then calculate the memory addresses to be accessed for fulfilling the request, and generates memory requests for these addresses. Continuing the example, the address calculation unit 310 generates addresses for the read requests by adding the stride length to the base address, then to each subsequently generated address until the indicated number of read request addresses are generated. The generated memory addresses are in the same memory address space as any memory addresses specified in the requested command received from the compute element. When the requested command is directed to a data structure, the address calculation unit 310 generates the memory access requests based on a corresponding data structure definition for the data structure that is stored in the data structure definition table.

A memory interface in the data structure engine 300 includes a set of memory request/store queues 321-323 and a set of memory response buffers 331-333. The memory access requests generated by the address calculation unit 310 are buffered in the memory request/store queues 321-323 prior to being issued to the memory controller by the memory interface 320. The memory interface 320 issues the memory requests to the memory controller and, in the case of read accesses, receives the requested data from memory in the memory response buffers 331-333. The memory response buffers 331-333 buffer data being returned from the memory that will be used for performing the operation requested by the compute element.

The data structure engine includes a set of data processors 341-343 and a local scratchpad memory 307 that work together to finish performing the command that was requested on the data that was retrieved. The request command processor 303 communicates the command to the data processor units 341-343 so the data processor units 341-343 can perform the appropriate requested computations, if any. The local scratchpad memory 307 is used in the computations (e.g., for storing intermediate results of the computations) and/or re-ordering data values (e.g., sorting, transformations, etc.). The data processors 341-343 and scratchpad memory 307 perform the functions listed above, such as compression, encryption, scan operations, etc. The local scratchpad memory 307 is also used for arranging blocks of data to be returned to the requesting device prior to transmission. In one embodiment, each of the data processors 341-343 performs a different function. In alternative embodiments, some or all of the data processors 341-343 perform the same or similar functions. The data processors 341-343 operate alone or with each other to perform computations for generating a set of result data based on the set of data originally retrieved from the memory. The result data is buffered in the output data/response queue 352 prior to being transmitted back to the requesting device.

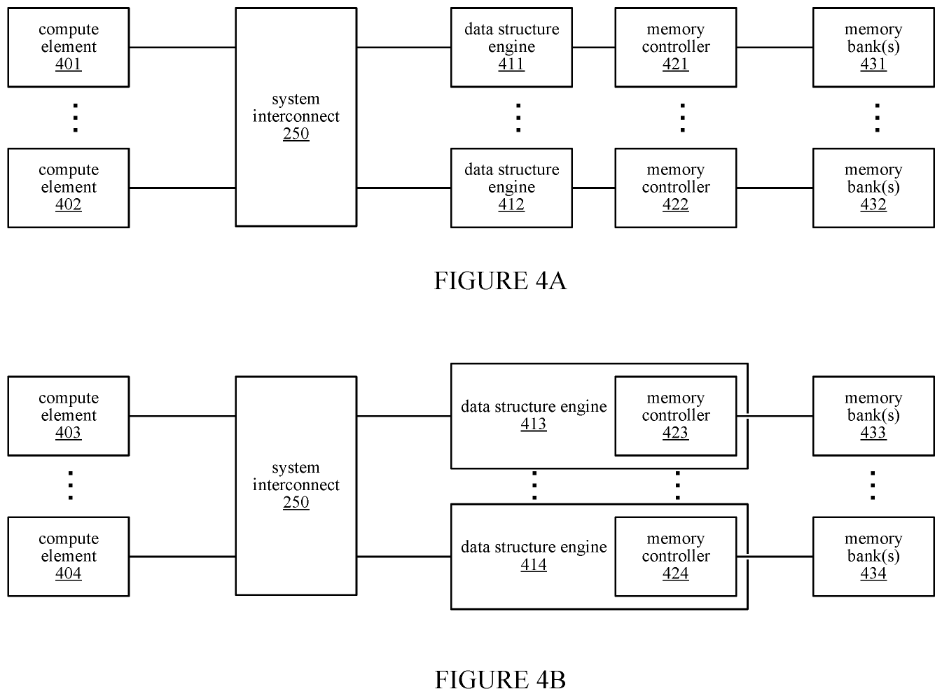

In one embodiment, data structure engines are distributed throughout the system 100, often implemented as near-memory functions to take advantage of the high memory bandwidth available there. FIG. 4A illustrates a computing system 100 including multiple data structure engines 411-412, according to an embodiment. Each of the data structure engines 411-412 functions in a similar manner as data structure engine 300, operates on a respective set of memory banks 431-432 or set of storage banks, and is located nearer to the memory (either physically, or in terms of communication latency) than to the compute elements 401-402. In one embodiment, a communication channel between the data structure engines 411-412 and the memory 431-432 has higher available bandwidth than a communication channel between the data structure engines 411-412 and the compute elements 401-402, since the communication pathway through the system interconnect 250 is physically longer and is shared with many other devices.

Each of the compute elements 401-402 (e.g., processor core, programmable logic, controller device, or other device) can send commands to any of the data structure engines 411-412 via the system interconnect 250. A data structure engine 411 receiving a command generates an appropriate set of memory access requests for carrying out the command, which are transmitted to the memory controller 421. The memory controller 421 accesses data in the memory bank 431 according to the memory requests and returns it to the data structure engine 411. The data structure engine 411 performs other computations, transformations, reordering, etc. of the data according to the command, then returns the finished data to the requesting compute element 401 or 402 via the system interconnect 250.

FIG. 4B illustrates a system 100 where the data structure engines 413-414 are collocated with memory controllers 423-424 for their respective memory banks 433-434, according to an embodiment. The data structure engines 413-414 each function in a similar manner as data structure engine 300, and reside on the same integrated circuit substrate or package as the respective memory controllers 423-424. With reference to FIGS. 4A and 4B, data structure engines can operate on storage bank devices such as solid state drives (SSDs), hard disks, etc. in similar fashion as for memory devices such as random access memory (RAM). Each of the data structure engines 411-414 issues memory access requests to a different portion of memory than any other of the data structure engines 411-414. In one embodiment, each of these different portions of memory resides in a different physical memory device. The data structure engines 411-414, memory/storage controllers 421-424, and memory/storage banks 431-434 are connected by one or more communication channels having higher throughput and/or lower transmission latency than the system interconnect 250.

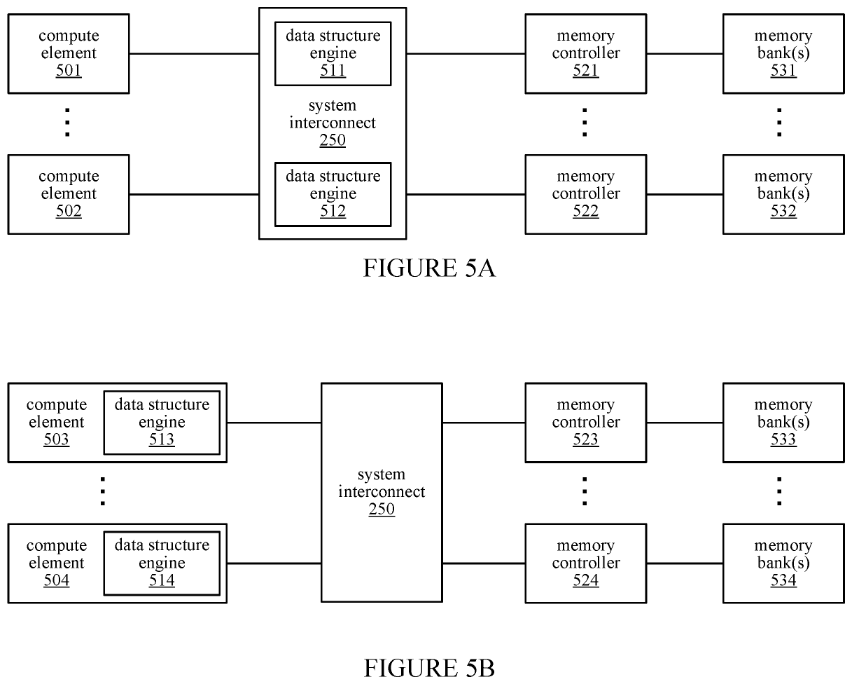

FIGS. 5A and 5B illustrate alternative placements of data structure engines 511-514 in a computing system 100, according to an embodiment. In FIG. 5A, data structure engines 511 and 512 function in a similar manner as data structure engine 300, and are incorporated in the system interconnect hardware 250 (e.g., incorporated into switch hardware or other devices in the interconnect 250). Commands issued by the compute elements 501-502 are transmitted over the interconnect 250 to the data structure engines 511-512, and the memory or storage access requests generated by the data structure engines 511-512 are transmitted over the interconnect 250 to the memory or storage controllers 521-522. In one embodiment, the portion of the system interconnect 250 serving as a communication pathway between the data structure engines 511-512 is utilized by fewer devices and has more available bandwidth for carrying the generated memory access requests, as compared to the portion of the interconnect 250 between the compute elements 501-502 and the data structure engines 511-512.

In FIG. 5B, each of the data structure engines 513-514 functions in a similar manner as data structure engine 300, and is collocated with a respective compute element 503-504. Commands issued from the compute elements 503-504 are transmitted to the data structure engines 513-514 via respective high bandwidth communication channels, then translated into a set of memory or storage access requests by the data structure engines 513-514, then transmitted over the system interconnect 250 to the memory or storage controllers 523-524. In one embodiment, the compute elements 503-504 can represent accelerators (e.g., graph processing engines) that can perform additional specialized functions on the data.

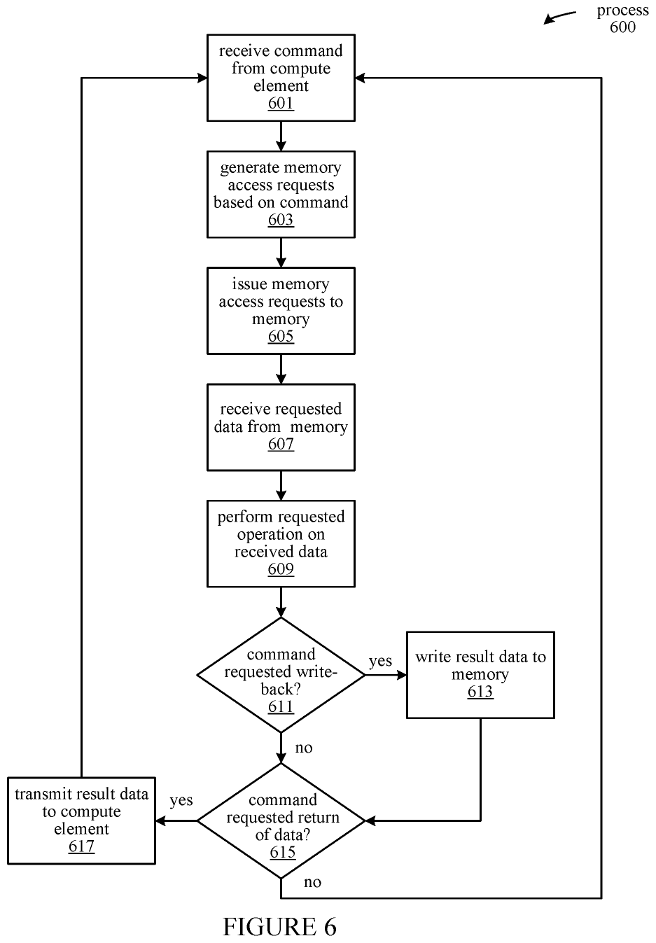

FIG. 6 illustrates a process 600 for operating a data structure engine, according to an embodiment. The process 600 is performed by components of the data structure engine 300. The data structure engine 300 performing process 600 may be positioned near a memory controller (e.g., data structure engine 411 and 412), collocated with a memory controller (e.g., data structure engines 413 and 414), in the system interconnect 250 (e.g., data structure engines 511 and 512), near a compute element (e.g., data structure engines 513 and 514), or elsewhere in the computing system 100 where it can communicate with a compute element and a memory device.

At block 601, the data structure engine 300 receives a command from a compute element (e.g., processing unit 201). The command is transmitted from the compute element to the data structure engine 300 via the system interconnect fabric 250, and requests an operation to be performed on data stored on a memory device that can be accessed by the data structure engine 300.

At block 603, the data structure engine 300 responds to the command by generating multiple memory access requests based on memory addresses indicated in the command. The generated memory access requests are directed to memory addresses in the same memory address space as the memory addresses specified in the command. In one example, the command indicates a base address, a stride length, and a number of memory access requests. The request command processor 303 provides this information to the address calculation unit 310, which generates the memory addresses to access by adding the stride length to the base address and to each subsequently generated address until the requested number of addresses have been generated.

When the command requests an operation to be performed on data that is organized in a data structure, the request command processor 303 obtains information about the data structure from the data structure description table 305. The data structure description table 305 contains information defining one or more data structures associated with data that may be requested by compute elements. For example, if the requested data is stored in an N×M matrix, the data structure description table 305 provides the dimensions N and M of the matrix so that the correct memory addresses are generated for matrix elements that are identified in the command by their rows and columns.

At block 605, memory interface 320 issues memory access requests based on the memory addresses generated by the address calculation unit 310. Outgoing memory access requests are queued in the memory request/store queues 321-323 and then issued to the memory controller of the data structure engine's associated memory device. The memory device receives the memory access requests and responds by sending the requested data. At block 607, the data structure engine receives the requested data from the memory device, and buffers the incoming data in the memory response buffers 331-333.

At block 609, one or more of the data processor units 341-343 perform the requested operation on the data received from the memory device to generate a set of result data. The request command processor 303 obtains the requested operation from the command and communicates it to the data processor units 341-343. The data processor units 341-343 obtains the data from the memory response buffers 331-333 and performs the operation on the data, using the local scratchpad memory 307 to store intermediate results of calculations as appropriate.

Some requested operations involve reordering some or all of the data or selecting a subset of the data to be sent back to the requesting compute element. Thus, the result data may include only a portion of the data that was retrieved from the memory device, or may include the same data in a different order. Some operations may involve selecting noncontiguous values from the data retrieved from the memory device, and returning only the selected values to the requesting compute element. The amount of result data may thus be less than the amount of data retrieved from the memory device. The reordered and/or selected data values are stored in the local scratchpad memory 307. Some requested operations involve arithmetic, logical, or other types of computations (e.g., compression, encryption, etc.) to be performed using the data. Intermediate results of these calculations and the final result data are stored in the local scratchpad memory 307.

At block 611, if the command requested that the result data be written back to the memory device, then at block 613, the data structure engine 300 writes the result data to the memory device by issuing memory write requests via the memory interface 320. From block 611 or 613, the process 600 continues at block 615. At block 615, if the command requested that the result data be returned to the requesting compute element, then at block 617, the data structure engine 300 returns the result data to the compute element by moving the result data from the local scratchpad memory to the output data/response queue, then transmitting the result data to the compute element via the system interconnect 250.

From block 617, the process 600 returns to block 601 to receive the next command from the compute element. Process 600 thus repeats to process multiple commands received from one or more compute elements in the system 100. The operation of data structure engines in the system 100 thus reduces the amount of data that is transmitted over the system interconnect, since data that will not be used by the compute element is not selected for transmission back to the requesting compute element. In addition, the data structure engine can perform requested computations near memory so that a set of result data that consumes less interconnect bandwidth is returned to the compute element. Some computations can be completed in the data structure elements and written back to the memory without returning any data to the requesting compute element, which also reduces the amount of data transmitted over the system interconnect 250.

As used herein, the term “coupled to” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a non-transitory computer-readable medium. These instructions may be used to program a general-purpose or special-purpose processor to perform the described operations. A computer-readable medium includes any mechanism for storing or transmitting information in a form (e.g., software, processing application) readable by a machine (e.g., a computer). The non-transitory computer-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory, or another type of medium suitable for storing electronic instructions.

Additionally, some embodiments may be practiced in distributed computing environments where the computer-readable medium is stored on and/or executed by more than one computer system. In addition, the information transferred between computer systems may either be pulled or pushed across the transmission medium connecting the computer systems.

Generally, a data structure representing the computing system 100 and/or portions thereof carried on the computer-readable storage medium may be a database or other data structure which can be read by a program and used, directly or indirectly, to fabricate the hardware including the computing system 100. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist including a list of gates from a synthesis library. The netlist includes a set of gates which also represent the functionality of the hardware including the computing system 100. The netlist may then be placed and routed to produce a data set describing geometric shapes to be applied to masks. The masks may then be used in various semiconductor fabrication steps to produce a semiconductor circuit or circuits corresponding to the computing system 100. Alternatively, the database on the computer-readable storage medium may be the netlist (with or without the synthesis library) or the data set, as desired, or Graphic Data System (GDS) II data.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be in an intermittent and/or alternating manner.

In the foregoing specification, the embodiments have been described with reference to specific exemplary embodiments thereof. It will, however, be evident that various modifications and changes may be made thereto without departing from the broader scope of the embodiments as set forth in the appended claims. The specification and drawings are, accordingly, to be regarded in an illustrative sense rather than a restrictive sense.

What is claimed is:

1. A method, comprising:
receiving from a compute element a command for performing a requested operation on data stored in a memory device; and
performing the requested operation by:
generating a plurality of memory access requests based on the command, and
issuing the plurality of memory access requests to the memory device.

2. The method of claim 1, further comprising:
from the memory device, receiving a first set of data for performing the requested operation, wherein:
the first set of data includes the data stored in the memory device, and
performing the requested operation further comprises generating a second set of data based on the data.

3. The method of claim 2, further comprising:
transmitting the second set of data to the compute element, wherein an amount of the second set of data is less than an amount of the first set of data.

4. The method of claim 2, wherein:
the second set of data comprises a subset of noncontiguous data elements from the first set of data.

5. The method of claim 2, further comprising:
writing the second set of data to the memory device, wherein generating the second set of data comprises reordering at least a portion of the first set of data.

6. The method of claim 1, wherein generating the plurality of memory access requests based on the command further comprises:
generating the plurality of memory access requests based on the command and based on a data structure definition table defining a data structure associated with the data.

7. The method of claim 1, wherein:
the plurality of memory access requests are generated based on a base address, a stride length, and a number of memory access requests indicated in the command.

8. The method of claim 1, wherein:
the plurality of memory access requests is directed to memory addresses in the same memory address space as one or more memory addresses specified in the command.

9. A data structure engine device, comprising:
a command processor configured to receive from a compute element a command for performing a requested operation on data stored in a memory device;
an address calculation unit coupled with the command processor and configured to generate a plurality of memory access requests based on the command; and
a memory interface coupled with the address calculation unit and configured to issue the plurality of memory access requests to the memory device.

10. The data structure engine device of claim 9, wherein:
the memory interface is further configured to receive from the memory device a first set of data for performing the requested operation,
the first set of data includes the data stored in the memory device, and
the data structure engine device further comprises a data processor coupled with the memory interface and configured to perform the requested operation by generating a second set of data based on the data.

11. The data structure engine device of claim 10, further comprising:
a system interconnect interface coupled with the data processor and configured to transmit the second set of data to the compute element, wherein an amount of the second set of data is less than an amount of the first set of data.

12. The data structure engine device of claim 10, further comprising:
a scratchpad memory; and
a data processor configured to generate the second set of data by performing computations on the data, wherein the scratchpad memory is configured to store intermediate results of the computations.

13. The data structure engine device of claim 9, further comprising:
a data structure definition table coupled with the address calculation unit, wherein the address calculation unit is configured to generate the plurality of memory access requests based a data structure definition stored in the data structure definition table.

14. The data structure engine device of claim 9, wherein:
the address calculation unit is further configured to generate the plurality of memory access requests based on a base address, a stride length, and a number of memory access requests indicated in the command.

15. The data structure engine device of claim 9, wherein:
the address calculation unit is further configured to direct the plurality of memory access requests to memory addresses in the same memory address space as one or more memory addresses specified in the command.

16. A computing system, comprising:
a compute element; and
a set of one or more data structure engines coupled with the compute element via a system interconnect, wherein each data structure engine of the set of one or more data structure engines is configured to:
receive from the compute element a command for performing a requested operation on data stored in memory; and
in response to receiving the command, perform the requested operation by:
generating a plurality of memory access requests based on the command, and
issuing the plurality of memory access requests to the memory.

17. The computing system of claim 16, wherein:
each data structure engine of the set of one or more data structure engines is configured for issuing the plurality of memory access requests to a different portion of the memory than any other data structure engine of the set, wherein each different portion of the memory resides in a different memory device.

18. The computing system of claim 16, wherein:
each data structure engine of the set of one or more data structure engines is collocated with a memory controller device for communicating with the memory.

19. The computing system of claim 16, wherein:
each data structure engine of the set of one or more data structure engines is located nearer to the memory than to the compute element.

20. The computing system of claim 16, wherein:
a first communication channel between the set of one or more data structure engines and the memory has higher bandwidth than a second communication channel between the set of one or more data structure engines and the compute element.
